(19) United States
(12) Patent Application Publication
(10) Pub. No.: US 2025/0359636 A1
(43) Pub. Date: Nov. 27, 2025

(54) BAG ASSEMBLY HAVING A FRONT PANEL ZIPPER ASSEMBLY AND TEAR STRIP

(71) Applicant: Illinois Tool Works Inc., Glenview, IL (US)

(72) Inventors: Eric P. Plourde, Frankfort, IL (US); David J. Matthews, Gilman, IL (US); Jose Manuel Septien Rojas, Naperville, IL (US)

(73) Assignee: Illinois Tool Works Inc., Glenview, IL (US)

(21) Appl. No.: 19/098,615

(22) Filed: Apr. 2, 2025

Related U.S. Application Data
(60) Provisional application No. 63/650,004, filed on May 21, 2024.

(51) Int. Cl. A44B 19/26; A44B 19/16; B31B 70/81; B31B 160/10; B65D 33/25; B65D 75/58

(52) U.S. Cl. CPC A44B 19/265; A44B 19/16; B31B 70/8131; B65D 33/2508; B65D 75/5827; B31B 2160/102

(57) ABSTRACT

A method can include obtaining a zipper assembly having front and rear flanges with interlocking elements that mate with and disengage from each other to provide a resealable opening into a bag assembly. The front flange can include a tear strip configured to be pulled away from the front flange to tear through at least one panel of the bag assembly and provide access to the interlocking elements and the resealable opening. The method also can include punching a hole through the front flange around the tear strip with a hole punch. The hole removing a first portion of the front flange and leaving a second portion of the front flange. The second portion of the front flange forming a pull tab connected to the tear strip and configured to be pulled to separate the tear strip from the front flange.

### CROSS-REFERENCE TO RELATED APPLICATIONS

This application claims priority to U.S. Provisional Application No. 63/650,004 (filed 21 May 2024), the entire disclosure of which is incorporated herein by reference.

### BACKGROUND

### Technical Field

The subject matter described herein relates to bag assemblies having zippers inside the bag assemblies along the front panels of the bag assemblies, and tear strips used to tear openings into the bag assemblies for accessing the zipper assemblies.

### Discussion of Art

Some known bag assemblies or pouches can have front-panel openings with press-to-close reclosable zippers. These bag assemblies can have the zippers coupled to inside surfaces of panels of the bag assemblies. The panels of the bag assemblies may be sealed together above the zipper assemblies so that consumers or users cannot access the zippers inside the bag assemblies. Tear strips may be disposed inside the bag assemblies above the zipper assemblies. The tear strips can be adhered to the zipper assemblies. The tear strips are grasped and pulled to tear openings into the bag assemblies. Users or consumers can reach into the bag assemblies through these tear strip openings to reach the zipper assemblies. The users or consumers can then pull apart the zipper assemblies to access the contents inside the bag assemblies (e.g., below the zipper assemblies).

To access and grasp the tear strips, some known current designs require access holes, cuts, or notches to be made at or close to one lateral side of the bag. These holes, cuts, notches, etc., typically penetrate through both the front and rear panels or walls of the bag assemblies, as well as the flanges of the zipper assemblies located between the front and rear panels or walls. In certain bag constructions, it may be preferable to only punch or cut the holes, cuts, notches, etc. through the flange that includes the tear strip and the front wall of the bag assembly, instead of punching or cutting through both flanges of the zipper assemblies. For example, cutting through both flanges of a zipper assembly may destroy a hermetic seal of the bag assembly that protects the contents within the bag assembly.

But cutting through only one of the two flanges of a zipper assembly can prove difficult due to the cutting occurring after the zipper assembly is sealed to the inside of the bag assembly. Therefore, a need may exist for a bag assembly and a method that includes or can provide a cut or punch through only one of the two flanges of the zipper assembly.

Some zipper assemblies include flanges of different heights. For example, the front flange may be shorter than the rear flange (measured in a direction extending from a top edge of the bag assembly to the opposite, bottom edge of the bag assembly, or vice-versa). The front flange may be coupled with the front panel of the bag assembly.

The front flange may include the tear strip. The taller back (or rear) flange can be attached to the front panel of the bag assembly above the top of the shorter front flange. The back flange may be unattached to the majority of the rear pouch panel. Sealing of the rear, and possibly the front, flange may be limited to the side or quad seal areas of the bag assembly. The front and back flanges may be sealed together with a weaker seal, such as a peel seal, to protect either panel. But this peel seal can make separating the tear strip from the back flange more difficult. This can result in frustration by the consumer or user, and may result in the tear strip tearing along an undesirable path. For example, the increased difficulty in separating the tear strip from the back panel may result in the tear strip being pulled in a direction that is transverse to the direction along which the tear strip is disposed in the front flange. As a result, the tear strip may tear through the front panel at an angle that causes the opening formed by the tear strip to not extend across the front panel.

### BRIEF DESCRIPTION

A zipper assembly described herein may include a front flange having a first interlocking element, and a rear flange opposing the front flange and having a second interlocking element. The front flange and the rear flange can be coupled with panels of a bag assembly. The first interlocking element of the front flange and the second interlocking element of the rear flange can mate with each other and to separate from each other to provide a resealable opening into an interior volume of the bag assembly. The zipper assembly also can include a tear strip coupled with the front flange. The tear strip can be pulled away from the front flange to tear through the at least one of the panels of the bag assembly and provide access to the resealable opening into the interior volume of the bag assembly. The tear strip can be connected with a pull tab formed from a portion of the front flange and can be pulled to separate the tear strip from the front flange, the pull tab located in an access hole extending through the front flange.

Another example of a zipper assembly can include a front flange having a first interlocking element, and a rear flange opposing the front flange and having a second interlocking element. The front flange and the rear flange can be coupled with panels of a bag assembly. The first interlocking element of the front flange and the second interlocking element of the rear flange can mate with each other and to separate from each other to provide a resealable opening into an interior volume of the bag assembly. The zipper assembly also can include a tear strip that can be coupled with the front flange. The tear strip can be connected to a pull tab formed from part of the front flange. This pull tab can be pulled to pull the tear strip away from the front flange to tear through the at least one of the panels of the bag assembly and provide access to the resealable opening into the interior volume of the bag assembly. The rear flange can include a release hole extending through the rear flange that can release the tear strip from the rear flange.

A method can include obtaining a zipper assembly having front and rear flanges having interlocking elements that can mate with and disengage from each other to provide a resealable opening into a bag assembly to which the zipper assembly is configured to be coupled. The front flange can include a tear strip configured to be pulled away from the front flange to tear through at least one panel of the bag assembly and provide access to the interlocking elements and the resealable opening. The method also can include punching a hole through the front flange around the tear strip with a hole punch. The hole removing a first portion of the front flange and leaving a second portion of the front flange. The second portion of the front flange forming a pull tab connected to the tear strip and configured to be pulled to separate the tear strip from the front flange.

### BRIEF DESCRIPTION OF THE DRAWINGS

The inventive subject matter may be understood from reading the following description of non-limiting embodiments, with reference to the attached drawings, wherein below:

FIG. 1 illustrates one example of a bag assembly;

FIG. 2 illustrates a zipper assembly of the bag assembly shown in FIG. 1;

FIG. 3 illustrates one example of a hole punch cutting through both flanges of the zipper assembly shown in FIG. 2;

FIG. 4 illustrates another example of the hole punch cutting through only one of the flanges of the zipper assembly shown in FIG. 2;

FIG. 5 illustrates another example of the hole punch cutting through only one of the flanges of the zipper assembly shown in FIG. 2;

FIG. 6 illustrates another example of the hole punch cutting through only one of the flanges of the zipper assembly shown in FIG. 2;

FIG. 7 illustrates one example of the hole punch cutting through both flanges of the zipper assembly shown in FIG. 2 while the zipper assembly is coupled with the bag assembly;

FIG. 8 illustrates another example of the hole punch cutting through the front bag wall and the front flange of the zipper assembly shown in FIG. 2 without cutting through the back flange while the zipper assembly is coupled with the bag assembly;

FIG. 9 illustrates another example of the hole punch cutting through the front bag wall and the front flange of the zipper assembly shown in FIG. 2 while the zipper assembly is coupled with the bag assembly and the back flange and the back bag wall are folded away;

FIG. 10 illustrates a front view of another example of a zipper assembly;

FIG. 11 illustrates a rear view of the zipper assembly shown in FIG. 10; and

FIG. 12 illustrates a flowchart of one example of a method for forming an access hole and/or tab for a tear strip in a bag assembly.

### DETAILED DESCRIPTION

One or more examples of the inventive subject matter described herein provide for the ability to cut a hole through only one of the flanges in a zipper assembly to provide access to the tear strip. A separator plate can be positioned between the flanges in a location that is above interlocking elements of the zipper assembly. For example, the separator plate can be placed between the flanges in a location where the interlocking elements are between the separator plate and portions of the flanges that will be inside the bag assembly (e.g., closer to the interior of the bag assembly than the separator plate). A hole punch may then move toward the separator plate to cut a hole through the portion of one of the flanges that is between the separator plate and the hole punch. The separator plate prevents the other flange from being cut by the hole punch. As a result, the hole formed by the hole punch may only extend through one of the flanges. This hole can provide a user or consumer of the bag assembly with access to the tear strip, allowing the user or consumer to grasp and pull the tear strip through the hole.

In another example, instead of using the separator plate, the portion of the flange through which the hole is not to be cut through can be moved to a position that the hole punch does not reach. For example, the back flange may be folded back such that a cutting path along which the hole punch moves to cut the hole in the front flange does not intersect the back flange. This also can result in the hole formed to provide consumer access to the tear strip extending through the front flange, but not the back flange.

The separator plate may be used, or the flange may be moved to a position that is not intersected by the hole punch cutting path before or after the zipper assembly is coupled with the panels or walls of the bag assembly.

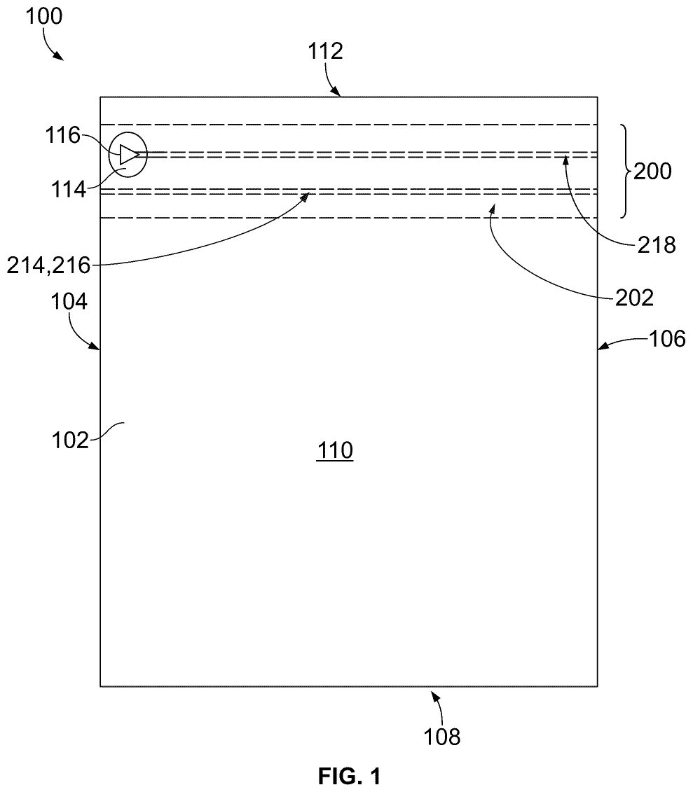

FIG. 1 illustrates one example of a bag assembly 100. The bag assembly 100 includes a front panel 102 coupled with a back panel (not visible in FIG. 1) along at least three sides, edges, or interfaces 104, 106, 108. Optionally, the bag assembly 100 may include gusseted sides between the front panel 102 and the back panel. For example, additional side panel may extend from the front panel 102 to the back panel along one or both of the side edges or interfaces 104, 106. The panels of the bag assembly 100 enclose an interior volume 110 of the bag assembly 100 in which a product can be stored. A top edge 112 of the bag assembly 100 may be closed. For example, the top edge 112 may be closed with the front and back panels coupled with each other along the top edge 112.

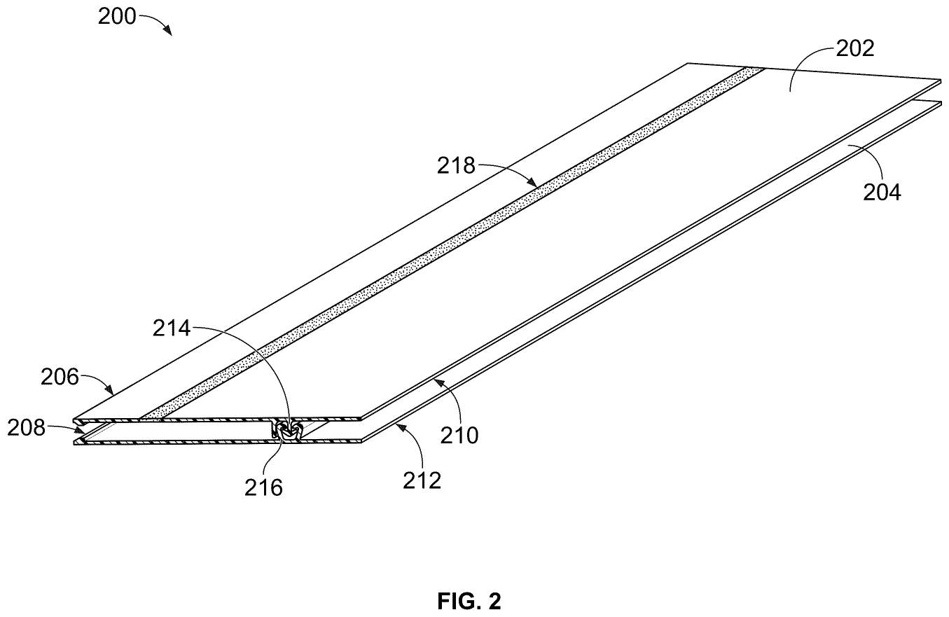

With continued reference to the bag assembly 100 shown in FIG. 1, FIG. 2 illustrates a zipper assembly 200 of the bag assembly 100. The zipper assembly 200 includes opposing flanges 202, 204 that may be coupled with one or both of the front and back panels of the bag assembly 100. In the illustrated example, the flanges 202, 204 are the same size. For example, each of the flanges 202, 204 may have the same height in that a top edge 206, 208 of each of the flanges 202, 204 is the same distance from the top edge 112 of the bag assembly 100 as each other, and an opposite, bottom edge 210, 212 of each of the flanges 202, 204 is the same distance from the bottom edge 108 of the bag assembly 100 as each other. Each of the flanges 202, 204 may be coupled with (e.g., adhered to) one of the panels of the bag assembly 100. For example, the front flange 202 may be adhered to an inside surface of the front panel 102 of the bag assembly 100 and the back (or rear) flange 204 may be adhered to an inside surface of the back panel of the bag assembly 100.

In another example, the flanges 202, 204 may be differently sized. For example, the flanges 202, 204 may have different heights in that the top edge 206, 208 of one of the flanges 202, 204 is a shorter distance from the top edge 112 of the bag assembly 100 than the other flange 204, 202. Each of the flanges 202, 204 may be coupled with one of the panels of the bag assembly 100, as described above. Optionally, both flanges 202, 204 may be adhered to the same panel (e.g., the front panel 102) of the bag assembly 100.

The flanges 202, 204 include interlocking elements 214, 216 that can be pressed together to engage and interlock with each other to close the interior volume 110 of the bag assembly 100. The interlocking elements 214, 216 can be pulled apart from each other to disengage from each other and open the interior volume 110 of the bag assembly 100. In the illustrated example, the interlocking element 214 is shown as a male member that is received into the female member of the interlocking element 216. Alternatively, the interlocking element 214 and/or 216 may have another shape. The interlocking elements 214, 216 can mate with each other and separate from each other multiple times to provide for a resealable opening into the interior volume 110 of the bag assembly 100.

In the illustrated example, the front flange 202 includes a tear strip 218. The tear strip 218 can be included in the flange 202 (e.g., co-extruded with or formed inside the flange 202) or can be attached to the surface or edge of the flange 202. The tear strip 218 can be made from a material that differs from, and is stronger than, the material from which the flanges 202, 204 are made. For example, the flanges, 202, 204 may be formed from low density polyethylene (LDPE) while the tear strip 218 is formed from high density polyethylene (HDPE), polypropylene (PP), or a cyclic olefin copolymer (COC). The tear strip 218 can release from the flange 202 either by tearing or pealing. When the flange 202 is covered by the front panel 102 of the bag assembly 100, the tear strip 218 is pulled to tear through the front panel 102 and create an opening in the front panel 102. This can allow a user or consumer to access the interlocking elements 214, 216 to pull and separate the interlocking elements 214, 216 and gain access to the interior volume 110 of the bag assembly 100.

The front panel 102 of the bag assembly 100 may include an access hole 114 through which the tear strip 218 is accessible from outside the front panel 102 of the bag assembly 100. The remainder of the tear strip 218 may be inaccessible from outside the bag assembly 100 as this remainder of the tear strip 218 is between the front panel 102 and the front flange 202 of the zipper assembly 200. This access hole 114 may only extend through the front panel 102 of the bag assembly 100 and the front flange 202 of the zipper assembly 200. The access hole 114 may not extend through the back flange 204 of the zipper assembly 200 or the back panel of the bag assembly 100.

As described below, a hole punch may be used to form the access hole 114 in the bag assembly 100 and in the zipper assembly 200. This hole punch may remove part, but not all, of the front flange 202, and may leave part of the front flange 202 connected with the tear strip 218. This part of the front flange 202 may be left to form a pull tab 116 that can be grasped by the user or consumer. For example, the pull tab 116 formed by a portion of the front flange 202 may be connected with the tear strip 218 by cutting the front flange 202 around the pull tab 116. This pull tab 116 may then be pulled by the user or consumer, thereby also pulling the tear strip 218. The tear strip 218 then separates from the front flange 202, tears through the front panel 102 of the bag assembly 100, and thereby provides access to the interlocking elements 214, 216. The tear strip 218 and front flange 202 are shown in FIG. 2 prior to cutting the front flange 202 with the hole punch to form the pull tab 116.

Optionally, the hole punch may be used to cut through both the front and back flanges 202, 204 in the zipper assembly 200. This can result in the pull tab 116 being formed from part of the front flange 202 with part of the back flange 204 also having the shape of the pull tab 116 cut through the back flange 204.

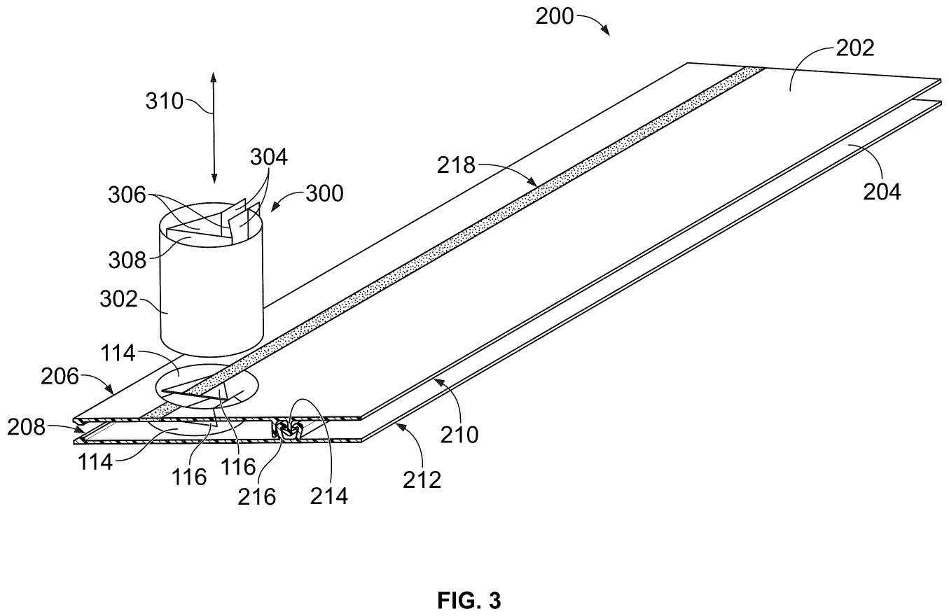

FIG. 3 illustrates one example of a hole punch 300 cutting through both the front and back flanges 202, 204 to form the pull tab 116 and access hole 114 in both the front and back flanges 202, 204. The hole punch 300 may be moved (e.g., by a motor, compressor, pump, etc.) toward and away from the zipper assembly 200 along a cutting path 310. For example, the hole punch 300 may be linearly moved toward and into the zipper assembly 200 along the cutting path 310 to cut away part of the front flange 202 and/or rear flange 204 and form the pull tab 116 and the access hole 114 through both the flanges 202, 204. As shown in FIG. 3, the pull tab 116 may be formed with part of the front flange 202 and part of the rear flange 204. The pull tab 116 formed from part of the front flange 202 may be coupled with the tear strip 218 due to the tear strip 218 being adhered to or part of the front flange 202 prior to the hole punch 300 cutting through the front flange 202.

The hole punch 300 may be formed by an outer or external blade 302 connected with one or more internal blades 304, 306, 308. In the illustrated example, the outer blade 302 extends along a circular path or shape. The internal blades 304 are disposed parallel to each other, and extend through or cross over this circular path or shape. Stated differently, the internal blades 304 cross over and protrude from the circular path or shape along which the outer blade 302 of the hole punch 300 extends. The internal blades 306 are connected with ends of the internal blades 304 that are inside the outer blade 302.

These internal blades 306 are oriented at an angle to each other such that the internal blades 306 are closest to each other at the intersections with the internal blades 304 and fan out or form a dovetail shape to an intersection with the internal blade 308. The internal blades 306 are closest to each other at the intersections between the internal blade 304 and the internal blades 306, and farthest from each other at the intersections between the internal blade 308 and the internal blades 306. In one example, the internal blades 304 can be referred to as parallel internal blades, the internal blades 306 can be referred to as angled internal blades, and the internal blade 308 can be referred to as an end internal blade.

The internal blades 304 may be spaced apart far enough to avoid cutting the tear strip 218. The outer blade 302 and the internal blade 308 may cut the tear strip 218 so that a gap is formed in the tear strip 218, as shown in FIG. 3. The internal blades 304, 306, 308 can cut or form a triangle-shaped pull tab 116. Alternatively, the external and/or internal blades 302, 304, 306, 308 may form a pull tab 116 having another shape. For example, the hole punch 300 may form a polygon shape or a shape having both curved and linear edges. The outer blade 302 and the internal blades 304, 306, 308 can cut the front flange 202 around the tear strip 218 to form the access hole 114. For example, the size and shape of the access hole 114 may be formed by the space between the outer blade 302 and the internal blades 304, 306, 308.

Once the zipper assembly 200 is coupled to the inside of the bag assembly 100, a user or consumer can grasp the pull tab 116 within the access hole 114 and pull the pull tab 116. This can cause the tear strip 218 to be pulled away from the front flange 202 and tear through the front panel 102 of the bag assembly 100, as described herein.

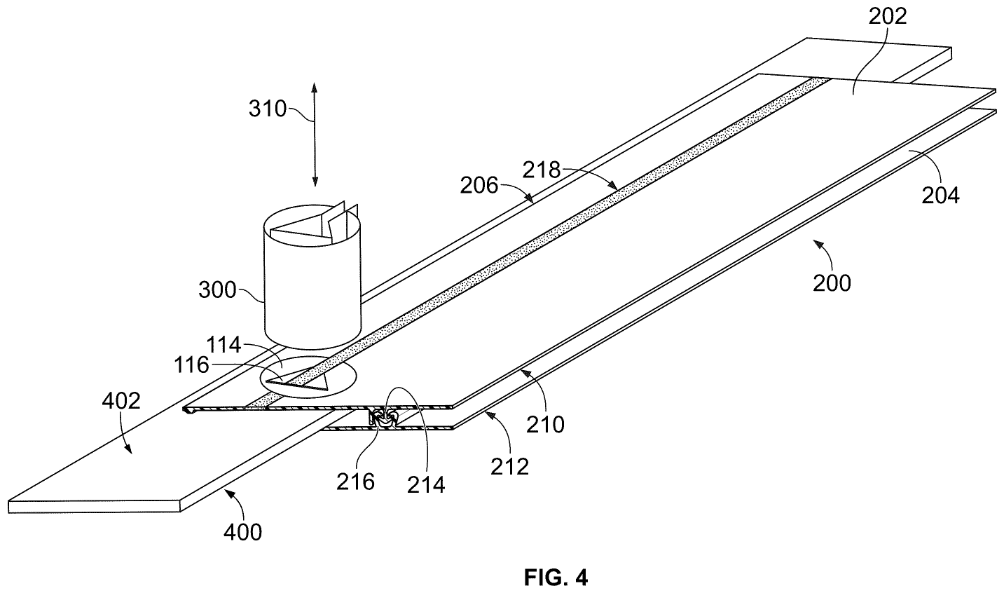

FIG. 4 illustrates another example of the hole punch 300 cutting through only the front flange 202 and not the back flange 204 to form the pull tab 116 and the access hole 114 in only the front flange 202 and not the back flange 204. It may be desirable to cut the access hole 114 in only the front flange 202 and not the back flange 204, such as for a more aesthetically pleasing bag assembly 100, to maintain a hermetic seal of the bag assembly 100, or the like.

A separator plate 400 may be used to impede cutting of the back flange 204 by the hole punch 300. The separator plate 400 may be formed from a material that is stronger and less prone to being cut by the hole punch 300 than the flanges 202, 204. For example, the separator plate 400 may be formed from a polymer material that is stiffer than the flanges 202, 204 to prevent damaging the lower cutting edges of the blades 302, 304, 306, 308 (labeled in FIG. 3). Optionally, the separator plate 400 may be formed from metal but with a polymer or foam coating on a surface 402 of the separator plate 400 that faces the front flange 202 that is being cut by the hole punch 300. This can prevent or reduce damage to the lower cutting edges of the blades 302, 304, 306, 308 (labeled in FIG. 3).

The hole punch 300 can be lowered along the cutting path 310 toward the front flange 202 of the zipper assembly 200. The lower edges or cutting edges of the hole punch 300 can cut through the front flange 202, similar to as described above in connection with FIG. 3. In contrast to the description of FIG. 3, however, the separator plate 400 can stop the hole punch 300 from cutting through the back flange 204. The separator plate 400 can limit the hole punch 300 to cutting the access hole 114 and forming the pull tab 116 in only the front flange 202. The back flange 204, on the other hand, can remain intact without the hole punch 300 cutting any part of the back flange 204.

In one example, the separator plate 400 can be placed between the flanges 202, 204 and the interlocking elements 214, 216 may remain mated with each other while the separator plate 400 is placed between the flanges 202, 204 and the access hole 114 is cut through the front flange 202. This can reduce the number of steps or actions that need to be performed to complete manufacture of the zipper assembly 200 and/or the bag assembly 100. For example, this can avoid having to re-mate or re-engage the interlocking elements 214, 216 with each other following cutting of the access hole 114.

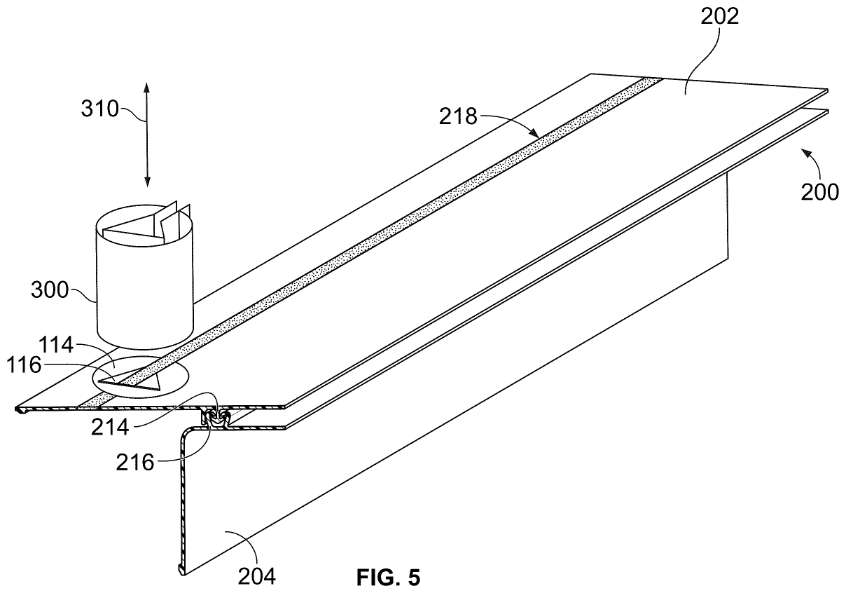

FIG. 5 illustrates another example of the hole punch 300 cutting through only the front flange 202 and not the back flange 204 to form the pull tab 116 and the access hole 114 in only the front flange 202 and not the back flange 204. Instead of using the separator plate 400 to only cut through the front flange 202, the rear flange 204 may be folded back or otherwise moved out of the way of the cutting path 310. The hole punch 300 can be lowered along the cutting path 310 toward the front flange 202 of the zipper assembly 200. The lower edges or cutting edges of the hole punch 300 can cut through the front flange 202 to form the access hole 114 and the pull tab 116, as described herein. The back flange 204 is not cut by the hole punch 300 due to the back flange 204 being folded away from the cutting path 310, as shown in FIG. 5. The front flange 202 may be placed on a support (e.g., a table or other working surface) to provide resistance as the hole punch 300 is lowered to cut the front flange 202. The back flange 204 can remain intact without the hole punch 300 cutting any part of the back flange 204. The support can include a cutout or opening that allows the portion of the front flange 202 that is cut to fall through the cutout. This can ensure that the portion of the front flange 202 that is cut from one bag does not interfere with the cutting of the portion of the front flange 202 in another bag that is placed on the support.

In one example, the back flange 204 can be folded back and away from the front flange 202 while the interlocking elements 214, 216 remain mated with each other and the access hole 114 is cut through the front flange 202. This can reduce the number of steps or actions that need to be performed to complete manufacture of the zipper assembly 200 and/or the bag assembly 100. For example, this can avoid having to re-mate or re-engage the interlocking elements 214, 216 with each other following cutting of the access hole 114.

Optionally, instead of folding the rear flange 204 back and away from the front flange 202, the front flange 202 can be folded away from the rear flange 204. This can still permit the hole punch 300 to cut the access hole 114 and form the pull tab 116 without cutting the access hole 114 or forming the pull tab 116 in the rear flange 204.

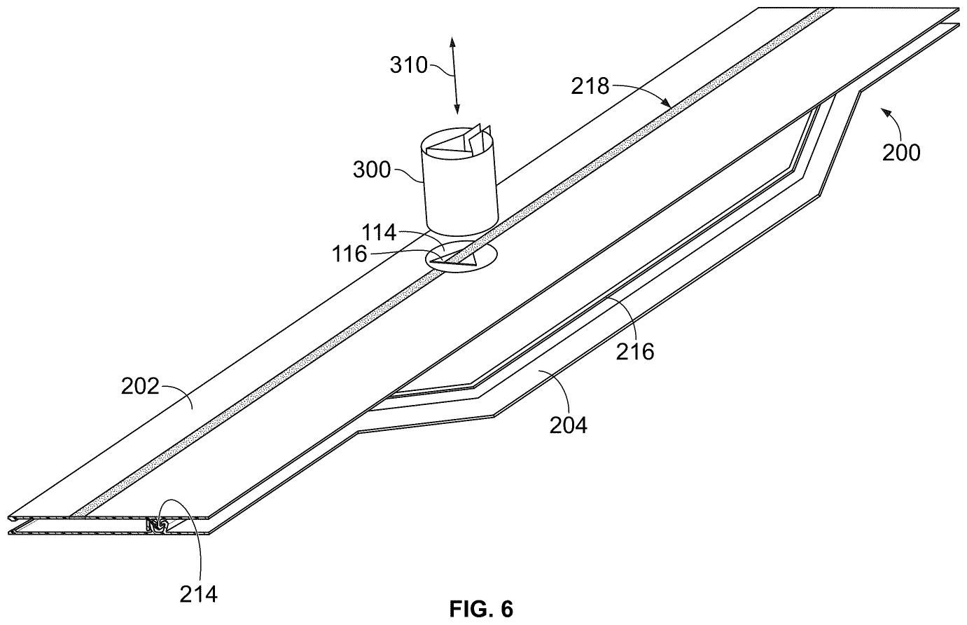

FIG. 6 illustrates another example of the hole punch 300 cutting through only the front flange 202 and not the back flange 204 to form the pull tab 116 and the access hole 114 in only the front flange 202 and not the back flange 204. In the examples shown in FIGS. 3 through 5, the access hole 114 and tab 116 are formed near one side (e.g., the left side) of the flanges 202, 204 of the zipper assembly 200. Optionally, the access hole 114 and pull tab 116 being formed in another location. For example, the access hole 114 and tab 116 can be formed farther from side or edge of the zipper assembly 200 and closer to the center of the zipper assembly 200, as shown in FIG. 6.

The interlocking elements 214, 216 of the flanges 202, 204 can be separated from each other across the location where the access hole 114 and tab 116 are to be formed. The flange 204 can then be lowered or otherwise moved away from the flange 202. The hole punch 300 can then be moved toward the flange 202 along the cutting path 310 to cut through the flange 202. The hole punch 300 may be moved toward the flange 202 far enough to cut through the flange 202 and the tear strip 218, but not through the flange 204. For example, the zipper assembly 200 may be held taut so that lowering the hole punch 300 can cut through the flange 202 and the tear strip 218. Optionally, the separator plate 400 may be placed between the flanges 202, 204 while the flanges 202, 204 are separated and the access hole 114 and tab 116 may be cut, as described above.

The examples described above in connection with FIGS. 3 through 6 illustrate cutting the access hole 114 and forming the pull tab 116 before the zipper assembly 200 is attached to the inside surface(s) of the front flange 202 and/or back flange 204. An additional access hole 114 can be cut through the front panel 102 that is aligned (e.g., coaxial with) the access hole 114 that is cut through the front flange 202. This additional access hole 114 may be cut with a hole punch that is the same as the hole punch 300 or with a hole punch that includes the outer blade 302 but not the interior blades 304, 306, 308 shown in FIG. 3. This can allow users or consumers to access the tab 116, as described above.

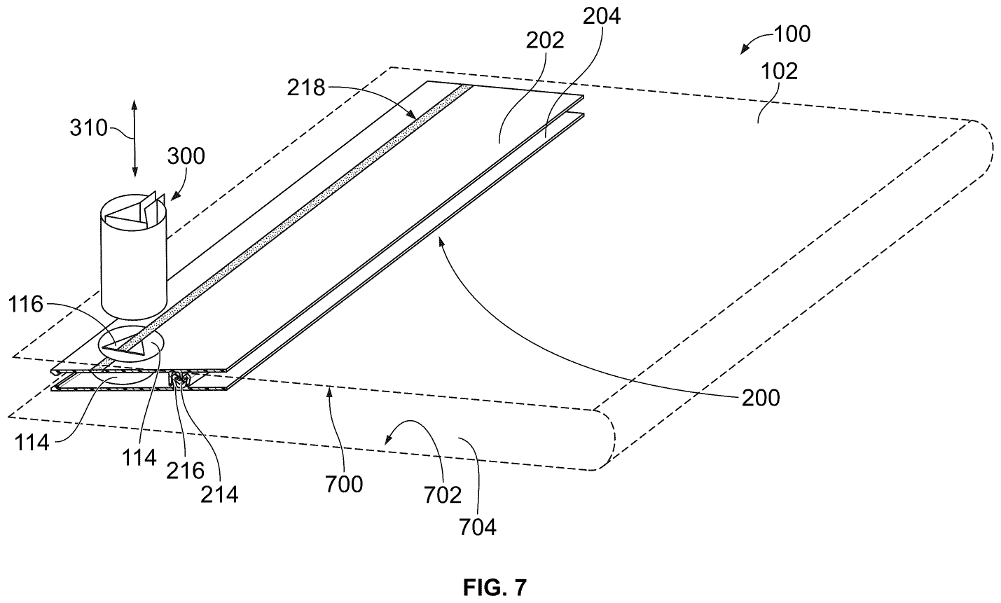

FIG. 7 illustrates one example of cutting the access hole 114 and forming the pull tab 116 in the front panel 102 of the bag assembly 100, the front flange 202 of the zipper assembly 200, and the back flange 204 of the zipper assembly 200 while the zipper assembly 200 is coupled with inside surfaces 700 and/or 702 of the front and back panels 102, 704 of the bag assembly 100. As shown, the zipper assembly 200 can be adhered to the inside surface 700 of the front panel 102 and, optionally, the inside surface 702 of a back panel 704 of the bag assembly 100. The hole punch 300 can be moved (e.g., lowered) along the cutting path 310 to cut through the front panel 102, the front flange 202, the tear strip 218, the back flange 204, and (optionally) the back panel 704. Alternatively, the hole punch 300 may be moved along the cutting path 310 to cut through the front panel 102, the front flange 202, the tear strip 218, and the back flange 204, but not the back panel 704. This can form the access hole 114 and the tab 118 as described above.

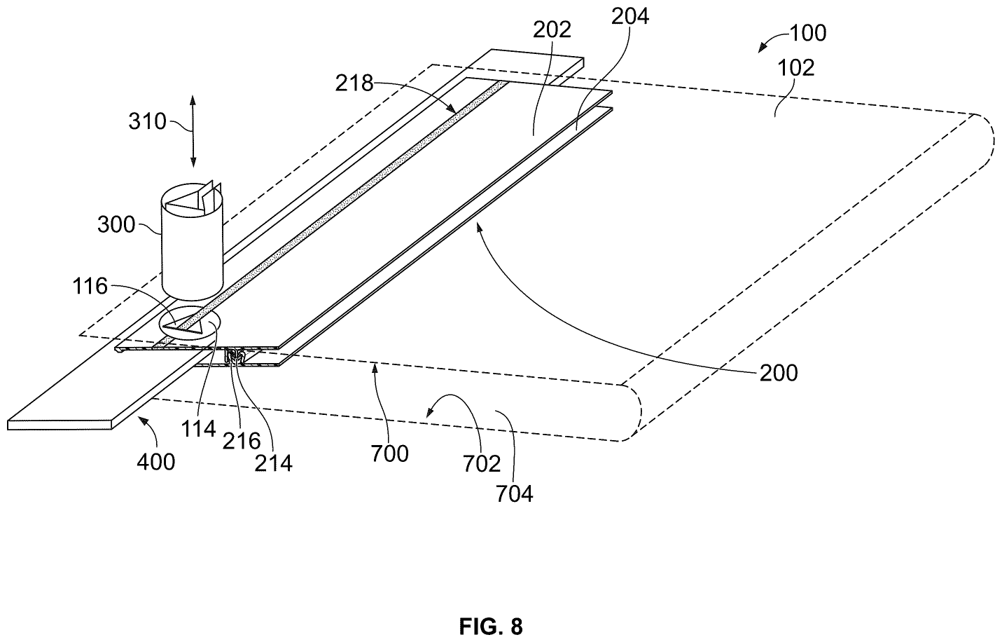

FIG. 8 illustrates another example of cutting the access hole 114 and forming the tab 116 in the front panel 102 of the bag assembly 100 and the front flange 202 of the zipper assembly 200 while the zipper assembly 200 is coupled with inside surfaces 700 and/or 702 of the front and back panels 102, 704 of the bag assembly 100. The back flange and back bag wall remain intact and are not cut through. The zipper assembly 200 can be adhered to the inside surface 700 of the front panel 102 and, optionally, the inside surface 702 of the back panel 704. The separator plate 400 can be positioned between the flanges 202, 204, as described above. The hole punch 300 can be moved (e.g., lowered) along the cutting path 310 to cut through the front panel 102, the front flange 202, and the tear strip 218 without cutting through the back flange 204 or the back panel 704. This can form the access hole 114 and the tab 118 through the front panel 102 and the front flange 202, as described above.

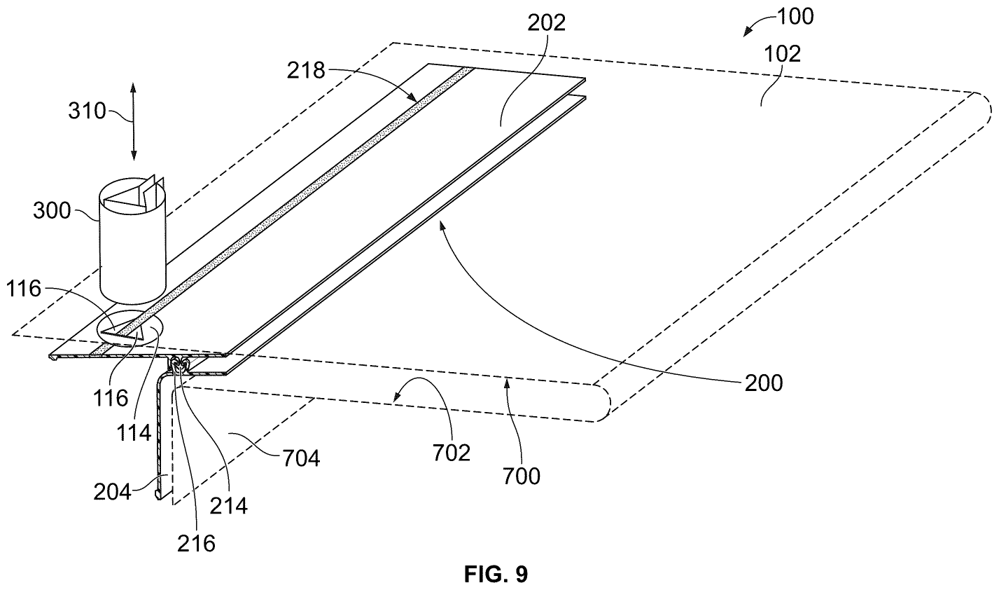

FIG. 9 illustrates another example of cutting the access hole 114 and forming the tab 116 in the front panel 102 of the bag assembly 100 and the front flange 202 of the zipper assembly 200 while the zipper assembly 200 is coupled with inside surfaces 700 and/or 702 of the front and back panels 102, 704 of the bag assembly 100. The zipper assembly 200 can be adhered to the inside surface 700 of the front panel 102 and, optionally, the inside surface 702 of the back panel 704. The back flange 204 of the zipper assembly 200 and the back panel 102 of the bag assembly 100 may be folded back and out of the way of the cutting path 310, as described above in connection with FIG. 5. The hole punch 300 can be moved (e.g., lowered) along the cutting path 310 to cut through the front panel 102, the front flange 202, and the tear strip 218 without cutting through the back flange 204 or the back panel 704. This can form the access hole 114 and the tab 118 through the front panel 102 and the front flange 202, as described above.

Additionally, in another example, the zipper assembly 200 may be coupled with the interior surfaces 700, 702 of the bag assembly 100. The interlocking elements 214, 216 of the flanges 202, 204 can be separated from each other across the location where the access hole 114 and pull tab 116 are to be formed. The flange 204 can then be lowered or otherwise moved away from the flange 202. The hole punch 300 can then be moved toward the front panel 102 and the flange 202 along the cutting path 310 to cut through the front panel 102 and the flange 202. The hole punch 300 may be moved toward the front panel 102 and the flange 202 far enough to cut through the front panel 102, the front flange 202, and the tear strip 218, but not through the back flange 204 or the back panel 704 of the bag assembly 100, as described above in connection with FIG. 6.

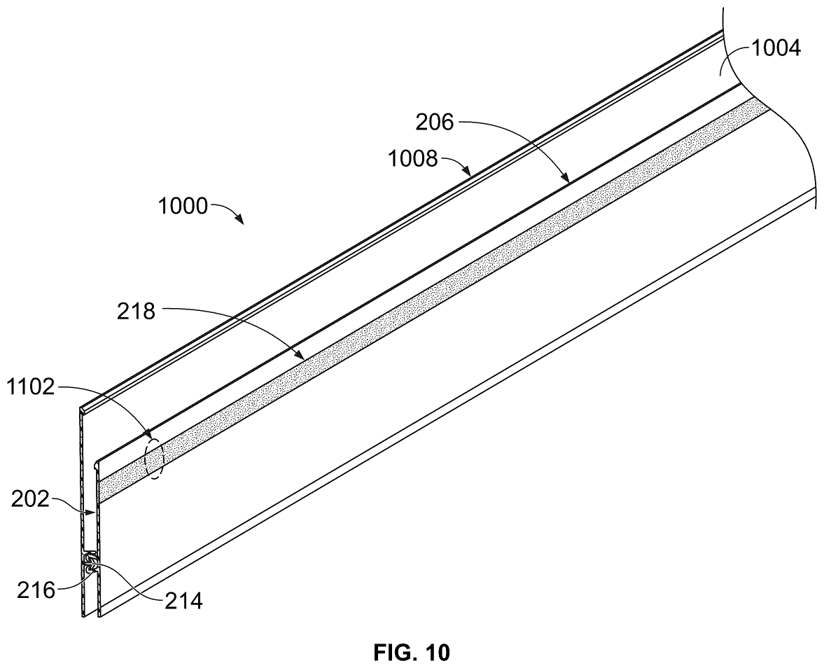

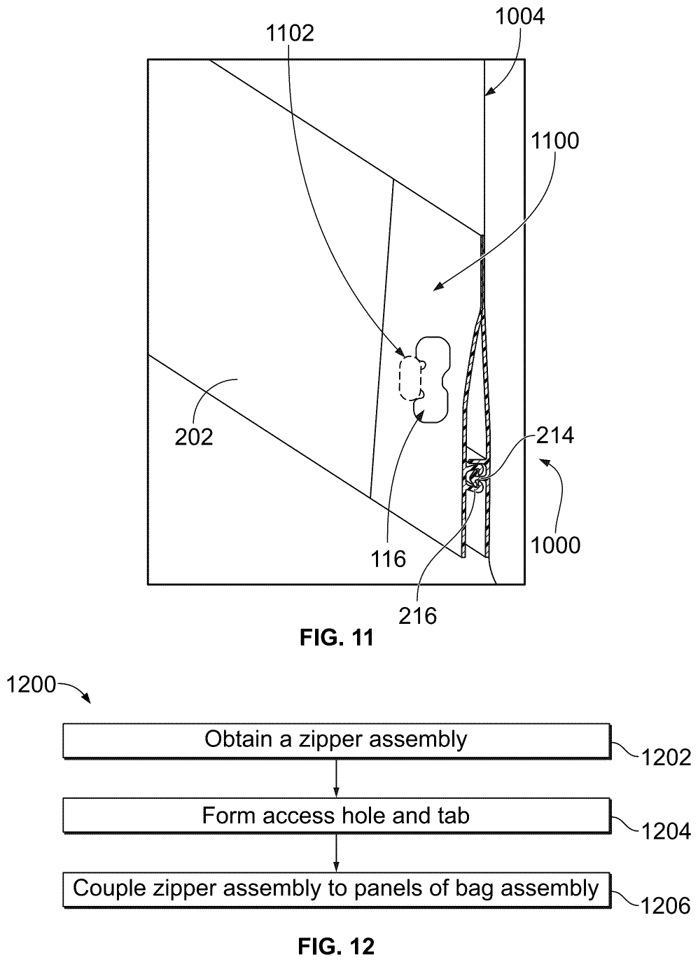

FIG. 10 illustrates a front view of another example of a zipper assembly 1000. FIG. 11 illustrates a rear view of the zipper assembly 1000 shown in FIG. 10. The zipper assembly 1000 may be similar to the zipper assembly 200 shown in FIG. 2 in that the zipper assembly 1000 includes the front flange 202 with the tear strip 218 and interlocking element(s) 214. The zipper assembly 1000 also includes a back or rear flange 1004 having the interlocking element(s) 216. One difference between the rear flange 1004 of the zipper assembly 1000 and the rear flange 204 of the zipper assembly 200 is that the rear flange 1004 is taller than the front flange 202 in the zipper assembly 1000. For example, a top edge 1008 of the rear flange 1004 may be closer to the top edge 112 of the bag assembly 100 (once the zipper assembly 1000 is coupled to the panels 102, 704 of the bag assembly) and/or farther from the interlocking elements 214, 216 than the top edge 206 of the front flange 202.

The shorter front flange 202 may be directly coupled with the inside surface 700 of the front panel 102 of the bag assembly 100. The taller rear flange 1004 may be directly coupled with the front panel 102 of the bag assembly 100 above the front flange 202. The rear flange 1004 may be unattached to the rear panel 704 of the bag assembly 100 along a majority of the length of the rear flange 1004 (with the length extending from one side edge 104 to the opposite side edge 106 of the bag assembly 100). The rear flange 1004 and/or the front flange 202 may be sealed to the front and rear panels 102, 704 of the bag assembly 100 at or near the side edges 104, 106 of the bag assembly 100 using side seals or quad seals 1100, as shown in FIG. 11. These seals 1100 can be formed by crushing or compressing ends of the zipper assembly 1000 and the panels 102, 704 toward each other. The rear flange 1004 may be sealed or coupled with the front flange 202, such as by a peel seal material or other adhesive.

One problem with this manner of sealing the zipper assembly 1000 to the panels 102, 704 is that it can be difficult to pull and separate the pull tab 116 and the tear strip 218 from the rear flange 1004. For example, the coupling between the flanges 202, 1004 can make it more difficult to separate the tab 116 and tear strip 218 in the front flange 202 from the rear flange 1004. To alleviate or reduce this difficulty, a release hole 1102 can be formed through the rear flange 1004.

The release hole 1102 can be an opening cut or formed in the rear flange 1004. This opening can extend through the rear flange 1004, but not through the tear strip 218 or the front flange 202. The release hole 1102 may be formed in the rear flange 1004 using a hole punch similar to as described herein, or may be otherwise cut through the rear flange 1004 from the surface of the rear flange 1004 that faces the rear panel 704 of the bag assembly 100 (or that faces away from the front flange 202).

The release hole 1102 may be placed through the rear flange 1004 in alignment with the tear strip 218. For example, the release hole 1102 may extend through the rear flange 1004 such that the release hole 1102 is disposed over the tear strip 218. The release hole 1102 may be positioned inside the pull tab 116 such that the tab 116 is located between the release hole 1102 and the side edge 104 that is closest to the release hole 1102 and the pull tab 116. The release hole 1102 allows the tear strip 218 to more easily separate from the rear flange 1104 compared to a zipper assembly not having the release hole 1102.

The release hole 1102 can be punched or cut through the rear flange 1104, and the zipper assembly 1000 can be sealed to the front panel 102 (e.g., both the front and rear flanges 202, 1004). The side seals 1110 can then be formed by crushing and fusing the flanges 202, 1104 of the zipper assembly 1000 together. Optionally, the portions of the zipper assembly 1000 that are within the side seals 1100 can be crushed or flattened first, and then sealed to the panels 102, 704 within the side seals 1100. The tab 116 and access hole 114 to access the tab 116 may then be formed through the front flange 202, as described herein.

The materials that are cut away from the bags and/or flanges may be referred to as slugs. The slugs may remain partially connected to the bags or flanges, and may need to be removed. Optionally, the slugs may be completely separated from and fall away from the bag and/or flanges.

FIG. 12 illustrates a flowchart of one example of a method 1200 for forming an access hole and/or tab for a tear strip in a bag assembly. The method 1200 can represent operations performed to create the access hole 114 and/or pull tab 116 described herein. At 1202, a zipper assembly with a tear strip is obtained. For example, the zipper assembly may be obtained by extruding or co-extruding the materials forming the zipper assembly and/or tear strip. Optionally, the tear strip may be separately formed and then adhered to the front flange.

At 1204, the access hole and/or tab are formed by cutting into the zipper assembly. In one example, a hole punch may push through and cut both flanges and the tear strip of the zipper assembly, as described above in connection with FIG. 3. In another example, a separator plate may be positioned between the flanges and then the hole punch may push through and cut the front flange and the tear strip to form the access hole and tab, with the separator plate preventing cutting of the rear flange. In another example, the rear flange may be bent away from the cutting path of the hole punch and then the hole punch may be pushed through the front flange to cut the access hole and form the tab.

In another example, the interlocking elements of the flanges may be separated, and the rear flange may be moved away from the front flange. The hole punch may then be pushed through and cut through the front flange to form the access hole and tab without cutting into or through the rear flange. At 1206, the zipper assembly may be coupled with the panels of the bag assembly. For example, the flanges of the zipper assembly may be adhered to the front and/or rear panels of the bag assembly. Alternatively, the order of operations 1204 and 1206 may be switched. For example, the zipper assembly can be coupled with the bag assembly and then the access hole and tab may be formed with the hole punch. Optionally, the method 1200 may include an additional operation of cutting a release hole through the rear flange of the zipper assembly. This release hole may be cut to provide for an easier release of the tear strip from the rear flange of the zipper assembly.

A zipper assembly described herein may include a front flange having a first interlocking element, and a rear flange opposing the front flange and having a second interlocking element. The front flange and the rear flange can be coupled with panels of a bag assembly. The first interlocking element of the front flange and the second interlocking element of the rear flange can mate with each other and to separate from each other to provide a resealable opening into an interior volume of the bag assembly. The zipper assembly also can include a tear strip coupled with the front flange. The tear strip can be pulled away from the front flange to tear through the at least one of the panels of the bag assembly and provide access to the resealable opening into the interior volume of the bag assembly. The tear strip can be connected with a pull tab formed from a portion of the front flange and can be pulled to separate the tear strip from the front flange, the pull tab located in an access hole extending through the front flange.

The access hole can extend through both the front flange and the rear flange. The access hole can separate the pull tab from a remainder of the front flange. The zipper assembly also can include a release hole extending through the rear flange that can release the tear strip from the rear flange. The release hole can be positioned with the pull tab between the release hole and a side edge of the rear flange.

Another example of a zipper assembly can include a front flange having a first interlocking element, and a rear flange opposing the front flange and having a second interlocking element. The front flange and the rear flange can be coupled with panels of a bag assembly. The first interlocking element of the front flange and the second interlocking element of the rear flange can mate with each other and to separate from each other to provide a resealable opening into an interior volume of the bag assembly. The zipper assembly also can include a tear strip that can be coupled with the front flange. The tear strip can be connected to a pull tab formed from part of the front flange. This pull tab can be pulled to pull the tear strip away from the front flange to tear through the at least one of the panels of the bag assembly and provide access to the resealable opening into the interior volume of the bag assembly. The rear flange can include a release hole extending through the rear flange that can release the tear strip from the rear flange.

The release hole can be positioned with the pull tab between the release hole and a side edge of the rear flange. The tear strip can be connected with a pull tab formed from a portion of the front flange and configured to be pulled to separate the tear strip from the front flange. The pull tab can be located in an access hole extending through the front flange. The access hole can extend through both the front flange and the rear flange. The access hole can separate the pull tab from a remainder of the front flange.

A method can include obtaining a zipper assembly having front and rear flanges having interlocking elements that can mate with and disengage from each other to provide a resealable opening into a bag assembly to which the zipper assembly is configured to be coupled. The front flange can include a tear strip configured to be pulled away from the front flange to tear through at least one panel of the bag assembly and provide access to the interlocking elements and the resealable opening. The method also can include punching a hole through the front flange around the tear strip with a hole punch. The hole removing a first portion of the front flange and leaving a second portion of the front flange. The second portion of the front flange forming a pull tab connected to the tear strip and configured to be pulled to separate the tear strip from the front flange.

The hole that is punched can extend through the front flange and the rear flange of the zipper assembly. Or the hole that is punched may extend through only the front flange of the zipper assembly. The method also can include placing a separator plate between the front and rear flanges of the zipper assembly. The hole can be punched through the front flange while the separator plate is between the front and rear flanges to prevent the hole punch from also punching the hole in the rear flange.

The method may include folding the rear flange away from the front flange. The hole is punched through the front flange while the rear flange is folded away from the front flange to prevent the hole punch from also punching the hole in the rear flange.

The method may include separating the interlocking elements of the front flange and the rear flange from each other, and moving the rear flange away from the front flange, wherein the hole is punched through the front flange while the rear flange is moved away from the front flange to prevent the hole punch from also punching the hole in the rear flange.

The method may include coupling the zipper assembly to panels of the bag assembly prior to punching the hole through the front flange around the tear strip with the hole punch.

The method can include folding the rear flange away from the front flange while the hole is punched through the front flange, placing a separator plate between the front flange and the rear flange while the hole is punched through the front flange, and/or separating the interlocking elements of the front flange and the rear flange from each other and moving the rear flange away from the front flange while the hole is punched through the front flange.

The hole that is punched can be an access hole. The method also can include punching a release hole through the rear flange of the zipper assembly in a location that overlaps the tear strip. The hole that is punched can create a gap in the tear strip at the pull tab.

The singular forms “a,” “an,” and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A zipper assembly comprising:
a front flange having a first interlocking element;
a rear flange opposing the front flange and having a second interlocking element, the front flange and the rear flange configured to be coupled with panels of a bag assembly, the first interlocking element of the front flange and the second interlocking element of the rear flange configured to mate with each other and to separate from each other to provide a resealable opening into an interior volume of the bag assembly; and
a tear strip coupled with the front flange, the tear strip configured to be pulled away from the front flange to tear through the at least one of the panels of the bag assembly and provide access to the resealable opening into the interior volume of the bag assembly, the tear strip connected with a pull tab formed from a portion of the front flange and configured to be pulled to separate the tear strip from the front flange, the pull tab located in an access hole extending through the front flange.

2. The zipper assembly of claim 1, wherein the access hole extends through both the front flange and the rear flange.

3. The zipper assembly of claim 1, wherein the access hole separates the pull tab from a remainder of the front flange.

4. The zipper assembly of claim 1, further comprising:
a release hole extending through the rear flange and configured to release the tear strip from the rear flange.

5. The zipper assembly of claim 4, wherein the release hole is positioned with the pull tab between the release hole and a side edge of the rear flange.

6. A zipper assembly comprising:
a front flange having a first interlocking element;
a rear flange opposing the front flange and having a second interlocking element, the front flange and the rear flange configured to be coupled with panels of a bag assembly, the first interlocking element of the front flange and the second interlocking element of the rear flange configured to mate with each other and to separate from each other to provide a resealable opening into an interior volume of the bag assembly; and
a tear strip coupled with the front flange, the tear strip connected to a pull tab formed from part of the front flange, the pull tab configured to be pulled to pull the tear strip away from the front flange to tear through the at least one of the panels of the bag assembly and provide access to the resealable opening into the interior volume of the bag assembly,
the rear flange including a release hole extending through the rear flange and configured to release the tear strip from the rear flange.

7. The zipper assembly of claim 6, wherein the release hole is positioned with the pull tab between the release hole and a side edge of the rear flange.

8. The zipper assembly of claim 6, wherein the tear strip is connected with a pull tab formed from a portion of the front flange and configured to be pulled to separate the tear strip from the front flange, the pull tab located in an access hole extending through the front flange.

9. The zipper assembly of claim 8, wherein the access hole extends through both the front flange and the rear flange.

10. The zipper assembly of claim 8, wherein the access hole separates the pull tab from a remainder of the front flange.

11. A method comprising:
obtaining a zipper assembly having front and rear flanges having interlocking elements configured mate with and disengage from each other to provide a resealable opening into a bag assembly to which the zipper assembly is configured to be coupled, the front flange including a tear strip configured to be pulled away from the front flange to tear through at least one panel of the bag assembly and provide access to the interlocking elements and the resealable opening; and
punching a hole through the front flange around the tear strip with a hole punch, the hole that is punched removing a first portion of the front flange and leaving a second portion of the front flange, the second portion of the front flange forming a pull tab connected to the tear strip and configured to be pulled to separate the tear strip from the front flange.

12. The method of claim 11, wherein the hole that is punched extends through the front flange and the rear flange of the zipper assembly.

13. The method of claim 11, wherein the hole that is punched extends through only the front flange of the zipper assembly.

14. The method of claim 11, further comprising:
placing a separator plate between the front and rear flanges of the zipper assembly, wherein the hole is punched through the front flange while the separator plate is between the front and rear flanges to prevent the hole punch from also punching the hole in the rear flange.

15. The method of claim 11, further comprising:
folding the rear flange away from the front flange, wherein the hole is punched through the front flange while the rear flange is folded away from the front flange to prevent the hole punch from also punching the hole in the rear flange.

16. The method of claim 11, further comprising:
separating the interlocking elements of the front flange and the rear flange from each other; and
moving the rear flange away from the front flange, wherein the hole is punched through the front flange while the rear flange is moved away from the front flange to prevent the hole punch from also punching the hole in the rear flange.

17. The method of claim 11, further comprising:
coupling the zipper assembly to panels of the bag assembly prior to punching the hole through the front flange around the tear strip with the hole punch.

18. The method of claim 17, further comprising one or more of:
folding the rear flange away from the front flange while the hole is punched through the front flange;
placing a separator plate between the front flange and the rear flange while the hole is punched through the front flange; or
separating the interlocking elements of the front flange and the rear flange from each other and moving the rear flange away from the front flange while the hole is punched through the front flange.

19. The method of claim 11, wherein the hole that is punched is an access hole, and further comprising:
punching a release hole through the rear flange of the zipper assembly in a location that overlaps the tear strip.

20. The method of claim 11, wherein the hole that is punched also creates a gap in the tear strip at the pull tab.
